(19) United States
(12) Patent Application Publication
(10) Pub. No.: US 2026/0253011 A1
(43) Pub. Date: Aug. 27, 2026

(54) SYSTEM AND METHOD FOR DEVELOPING OPTIMIZED WORK SCHEDULES

(71) Applicant: Kingfisher Innovations, Inc., Houston, TX (US)

(72) Inventors: Andrew Brett Gilmer, Parkland, FL (US); Mitchell Gilmer, Wauwatosa, WI (US); Steve Gotberg, Corpus Christi, TX (US); Theresa Ruiz, Little Elm, TX (US); RhaeAnn C. Stark, Corpus Christi, TX (US); Mitchell Kalogridis, Houston, TX (US)

(73) Assignee: Kingfisher Innovations, Inc., Houston, TX (US)

(21) Appl. No.: 19/063,690

(22) Filed: Feb. 26, 2025

(51) Int. Cl. G06Q 10/0637; G06Q 10/0639; G06Q 10/1053; G06Q 50/26

(52) U.S. Cl. CPC G06Q 10/06375; G06Q 10/06398; G06Q 10/1053; G06Q 50/26

(57) ABSTRACT

The invention provides a computer-implemented method and system for developing optimized work schedules in workplace environments. Employees are classified into performance categories based on metrics such as sales figures, customer feedback, task completion rates, and adherence to schedules, using an unbiased AI system that excludes factors like gender, race, and age. Availability data, including shift preferences and real-time location, is integrated with anticipated sales targets to determine an optimal staffing mix. Work schedules are generated in compliance with labor laws and workplace policies, ensuring operational efficiency while preventing overtime. Employees can access real-time rankings and performance evaluations, fostering transparency and accountability. The system also integrates with payroll to ensure fair task allocation and evaluates anomalies in sales and profitability, updating policies and schedules to enhance outcomes.

### FIELD

The present invention relates to developing optimized work schedules based on anticipated sales data projected from historical sales data and historical performance data for employees in a workplace environment. The system evaluates historical sales data and forecasts sales data accounting for year over year sales differences. The system then recommends an optimal mix of staff for each upcoming shift based on projected sales. The system categorizes employees by role, skillsets, and historical performance measured against collected KP data. The system then builds a balanced schedule by matching employees to the shift based on employee categorization, availability, and compliance factors. The system then presents the generated schedule to the planning manager for approval. This results in a dramatic reduction in the time required to build schedules and account for compliance issues, and the resulting schedule will dramatically increase profitability by avoiding over and under resourced shifts and optimizing employee utilization. The system also provides employees with a portal where they can manage their shifts, reducing the overhead of schedule conflict resolution for management and optimizing employee retention by generating increased employee satisfaction.

### BACKGROUND

Efficient workforce management is a critical component of operational success across industries, particularly in workplaces with dynamic staffing requirements, such as retail, hospitality, and customer service. In many SMB workplaces, work schedules are created based on manual inputs, basic availability data, or seniority hierarchies, which often result in inefficiencies, unfair task allocation, and compliance issues. These challenges are further compounded by biases, lack of real-time performance evaluation, and the absence of mechanisms to prevent overwork or optimize productivity.

Existing workforce management solutions do not tie worker KPIs to actual impact on realized sales data, and they are often difficult to use properly and still leave significant opportunities to introduce bias in scheduling.

Also, these workforce management systems do not tie back to actual employee performance based on sales data or provide workers with running feedback to improve their performance. Employees may remain unaware of the criteria determining their eligibility for promotions or dismissal, leading to dissatisfaction and disengagement. The lack of unbiased, real-time evaluation mechanisms also hinders equitable evaluation and allocation of tasks, contributing to inefficiencies and morale issues.

In addition, improper scheduling can result in significant operational drawbacks, including understaffed or overstaffed shifts, suboptimal task distribution, financial discrepancies, and non-compliance with labour laws. The absence of predictive analysis and anomaly detection mechanisms prevents organizations from identifying and addressing patterns that negatively affect sales, profitability, and employee productivity. Some workforce management systems currently offer manual interfaces that allow adjustments to scheduling in anticipation of certain events. However, these systems typically fall short because they lack a systematic way to modify scheduling forecasts based on dynamic external factors such as events, weather conditions, or other environmental elements that could influence sales outcomes. This limitation means that while schedules can be manually tweaked in response to expected changes, there isn't an automated, data-driven process in place to efficiently recalibrate workforce allocations based on real-time environmental data. This gap can result in suboptimal staffing, potentially leading to either understaffing or overstaffing, both of which can negatively impact operational efficiency and profitability. Incorporating a mechanism that automatically adjusts schedules in response to such factors could greatly enhance the adaptability and effectiveness of workforce management systems.

These systems also fall short of real-time adaptability when employee availability changes. When an employee calls out sick or otherwise unavailable, the replacement employee is hastily identified from the available and willing without regard to the effect of the additional work time on regulatory compliance or the suitability of the replacement based on the expected activity level of the available shift.

The present invention addresses these challenges by introducing a comprehensive AI-driven system and method for simplifying and optimizing workforce scheduling and performance management.

### SUMMARY

The following summary is illustrative only and is not intended to be in any way limiting. In addition to the illustrative aspects, example embodiments, and features described, further aspects, example embodiments, and features, will become apparent by reference to the drawings and the following detailed description.

According to an embodiment of the present invention, a computer-implemented method for developing work schedules for a plurality of employees in a workplace environment is disclosed. The method comprises classifying employees into one or more performance categories based on their objective and realized performance data, determining a staffing mix for each shift using these performance categories and anticipated sales targets, and generating a work schedule that complies with workflow policies and regulatory requirements. The method also includes the periodic (e.g. hourly) monitoring of actual sales data of each worksite and suggesting updated work schedules/staffing based on the monitored sales data compared to the anticipated sales targets that the schedules were originally based upon. The updated work schedules will continue to optimize staffing mixes to meet the sales targets efficiently.

Employee availability, regulatory requirements, and workflow policies play critical roles in the implementation of this method to create the schedule.

Employees' availability is managed by the employee through a worksite-branded portal (e.g. mobile app or web site). Employees may set the hours that they are available and block out hours that they are not available. The scheduling system will utilize this data during the schedule creation and during any modifications.

Regulations pertain to objective legal facts regarding business operation. Regulatory requirements generally serve to limit the number of hours certain employees may work. Regulatory requirements include but are not limited to applicable labor laws, OSHA limitations, exemption status, salary status, and overtime status.

Workflow policies pertain to the standard of quality set by the management for optimal operations (profitability, customer satisfaction, etc.). Workflow polices include but are not limited to ensuring at least a certain threshold of staffing headcount is meet for each role, ensuring a proper ratio of one staffing role to another (example: two Cashiers for every three cooks), and targeted payroll: sales ratios.

Performance data, measured by Employee KPI (Key Performance Indicators) are created for the purpose of tangible evaluations of an employee's performance and form a foundational component of this method. KPIs comprise metrics such as historical sales figures, experience, qualifications, customer feedback, gratuities, peer feedback, task-specific efficiency, and policy adherence. These data points enable the classification of employees into performance categories, which are then utilized to develop optimized staffing mixes for shifts.

The method incorporates a ranking system to evaluate employees based on performance data, explicitly excluding biasing factors such as gender, race, and age. This ranked list serves as a basis for schedule shift assignments, ensuring fairness while adhering to overtime thresholds to prevent overburdening employees. The method employs a dual scheduling strategy, dividing its focus between standard weekly schedule assignments and responsive adjustments such as fast call-ins or dismissals. It incorporates a ranking system that evaluates employees based on performance data, explicitly excluding biasing factors such as gender, race, and age. This ranked list serves as the foundation for assigning shifts in the weekly schedule, ensuring fairness and adherence to labor standards, including overtime thresholds to prevent overburdening employees. Additionally, this system of ranking also facilitates quick and efficient rescheduling, allowing for swift call-ins or dismissals based on immediate operational needs, while maintaining a fair and systematic approach to workforce management.

Monitoring plays a vital role in the method, with real-time data on employee locations, timesheet data, performance, sales, and profitability being recorded over a predefined period. This data is stored in a database in a time-series format, enabling comprehensive analysis. The Real Time Adjustment Engine evaluates this data to detect anomalies in workplace policies, staffing mixes, and work schedules. When significant deviations from anticipated sales and profitability occur, the system updates these parameters to enhance workplace performance.

The system also provides employees with access to their rankings, which include real-time evaluations and performance data. This transparency encourages employee engagement and motivates performance improvements. Additionally, rankings are used to determine eligibility for promotions or dismissals, contributing to career progression and workforce optimization. This system protects against accusations of unfairness and bias from employee evaluations, protecting a business from costly lawsuits.

The disclosed system for developing work schedules comprises several specialized modules, including a categorization module for classifying employees, a scheduling module for determining staffing mixes and generating compliant schedules, and a monitoring module for tracking real-time employee data. A feedback module is also included to provide actionable insights for updating schedules and workflow policies. Data storage is handled by a database that maintains records of employee activities and shift profitability in a structured, time-series format.

By integrating advanced data analysis with employee availability, workflow policies, employee KPI data, and regulatory requirements, the disclosed method and system offer a robust solution for workforce management. The incorporation of real-time monitoring, dynamic ranking, and feedback-driven optimization ensures that work schedules are not only efficient and compliant but also adaptable to changing workplace conditions and targets. Overall, the invention provides a comprehensive and ethical approach to workforce management. It ensures compliance with regulatory requirements, enhances operational efficiency, and fosters a transparent and fair evaluation system that benefits both employees and employers. By integrating advanced AI capabilities with real-time data analysis, the system addresses the challenges of scheduling, performance management, and profitability optimization in a modern workplace.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of a system for developing work schedules for a plurality of employees in a workplace environment, according to an example embodiment;

FIG. 2 is a block diagram of a workplace environment in which the system of FIG. 1 is deployed, according to an example embodiment;

FIG. 3 is a flow diagram illustrating a process of creating and updating workflow policies and work schedules for the workplace environment of FIG. 2, according to an example embodiment;

FIG. 4 is a flow diagram illustrating a process of categorizing employees of the workplace environment based on performance data and integrating the categorization with creating an optimized work schedule, according to an example embodiment;

FIGS. 5A-5E illustrates an interface of the system of FIG. 1, facilitating creation of workplace policies for a zone of the workplace environment, according to an example embodiment;

FIGS. 6A-6E illustrates an interface of the system of FIG. 1, where violation of workplace policies is illustrated, according to an example embodiment;

FIG. 7 is a flowchart illustrating a method for developing work schedules for a plurality of employees in a workplace environment, according to an example embodiment; and

FIG. 8 illustrates an interface for evaluation of an employee of the workplace, according to an example embodiment.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, elements, and/or components, but do not preclude the presence or addition of one or more other features, integers, steps, operations, elements, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The present invention discloses a computer-implemented method and system for developing optimized work schedules for employees in workplace environments. The method involves classifying employees into performance categories based on metrics such as sales figures, qualifications, and feedback, determining staffing mixes for each shift using these categories and anticipated sales targets, and generating schedules that comply with workplace policies and labor regulations. Real-time monitoring of employee location, availability, and performance data enables the system to suggest updates to schedules, ensuring efficient staffing and adherence to overtime thresholds. The system integrates modules for categorization, scheduling, monitoring, and feedback, supported by a database that records time-series data on employee activities, profitability, and shift performance. It identifies anomalies in workplace policies or schedules and implements data-driven updates to optimize staffing, enhance productivity, and maintain compliance, making it suitable for a variety of operational settings.

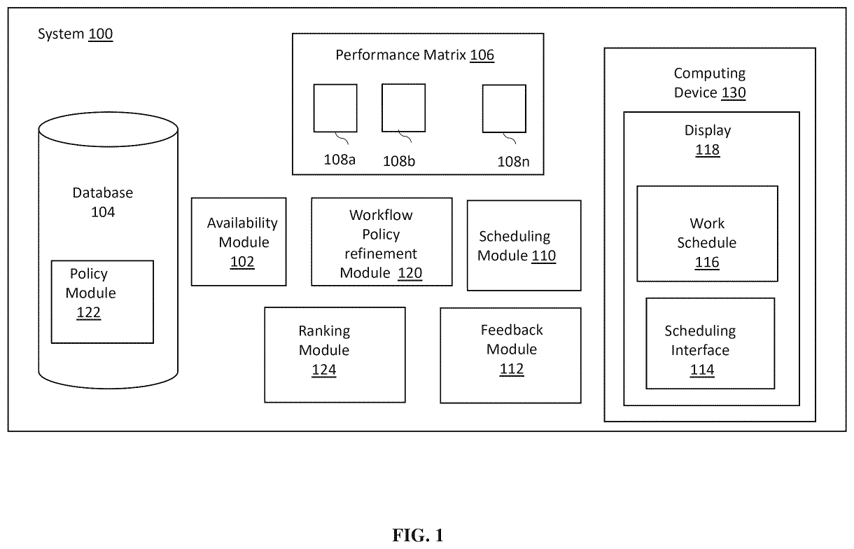

FIG. 1 is a block diagram of a system 100 for developing work schedules for a plurality of employees 108a-108n in a workplace environment, according to an example embodiment. The system 100 includes an availability module 102, a database 104, a performance matrix 106, a scheduling module 110, a feedback module 112, a workflow policy refinement module 120, a work schedule 116, a display 118, a computing device 130. The database 104 includes a policy module 122. The system 100 is designed to optimize the development of work schedules 116 for numerous employees in a workplace environment, showcasing advanced technological integration and functionality. Central to this system is the computing device 130, which is equipped with the display 118. This computing device 130 includes a display 118 is programmed with specific instructions to effectively implement and manage work schedules (e.g. 116), thereby serving as the command centre for scheduling operations via a scheduling interface 114.

Additionally, an integral component of this system is the availability module 102. The availability module 102 is specifically configured to interface with an integrated scheduling system, from which it retrieves the availability data of each employee. This data is crucial as it informs the system of when employees are available to work, allowing for the creation of work schedules that are not only efficient but also tailored to the availability and preferences of the workforce. This streamlined approach ensures that the work schedules are both practical and aligned with the operational needs of the workplace, enhancing overall productivity and employee satisfaction.

The modules in the system can be implemented as software components, hardware processors, or advanced AI engines, each designed to perform specific tasks and deliver actionable outputs. These modules are configured to function based on a plurality of predefined rules, leveraging algorithms and historical data to produce tangible results. For example, computer blocks can execute logical operations to classify employees into performance categories, processors can handle complex calculations to optimize work schedules, and AI engines can analyze patterns and adapt recommendations using machine learning techniques. By training these modules on diverse rules, including workplace policies, labor laws, and operational data, they can generate outputs such as optimized staffing mixes, updated schedules, or anomaly detection reports, thus enhancing efficiency, compliance, and decision-making within the system.

The invention uses machine learning to analyze historical sales data for each employee to determine the metrics that significantly impact actual sales and profitability. This analysis is used to develop a generalized classification model that measures employee performance on the metrics that impact sales and profitability and applies classifications to the employees based on actual performance data. The invention includes an integrated scheduling system that forecasts sales by shift, accounting for historical same week sales, year over year sales differences, user configured events that may impact sales, and weather data that may impact sales. Based on these forecasts, the integrated scheduling software creates an optimal staff allocation for each shift based on role, skillset, and performance classification. The system then maps potential staff to the optimized allocation, taking into account staff preferences, availability, skillsets, data-driven performance classification, and allocations that could produce compliance issues. The system then auto-generates a potential schedule for manager review, accelerating schedule creation and reducing bias. When the manager approves the schedule, the system forwards the schedule to the scheduled employees, providing an interface where employees can self-manage conflicts with the generated schedule, reducing the time required for managers to reconcile the schedule with shifting staff needs.

Additionally, the current invention exposes real-time performance data on a management dashboard to evaluate the effectiveness of the generated schedules and fine tune future schedules. The dashboard will also provide a view of employee performance raw metrics and classifications that can serve as inputs to performance reviews along with manager evaluations, and the invention will provide an employee view of the metrics used as inputs to performance reviews, enabling employees to monitor their ongoing rating on performance metrics and improve their performance.

The availability module 102 is designed to monitor and manage employee data effectively over a predefined time period, focusing on key parameters such as location, availability, and performance. It tracks a real-time location and activities of each employee (e.g. 108a), ensuring that their movements and tasks are accurately recorded. This data includes specific metrics like real-time location, activity logs, and associated sales and profitability figures, which are systematically stored in the database 104 for comprehensive analysis. Furthermore, the availability module 102, captures and logs the sales and profitability data of each shift, allowing for a granular understanding of individual and collective performance trends over the predefined time period. This approach ensures data integrity and provides actionable insights for optimizing workforce management and operational efficiency.

Another embodiment of the invention is the swapping of employees when an employee calls sick or becomes unable to fulfill the assigned schedule. As soon as an input is entered reflecting the unavailability of the employee, the system swaps the employee with another employee using artificial intelligence to review current tally of worked hours per employee, regulation policies, historic profitability of employees on a particular shift and suggest an optimized schedule choosing the best fit for the shift while optimizing profitability, complying with regulatory requirements and taking into account employee preferences.

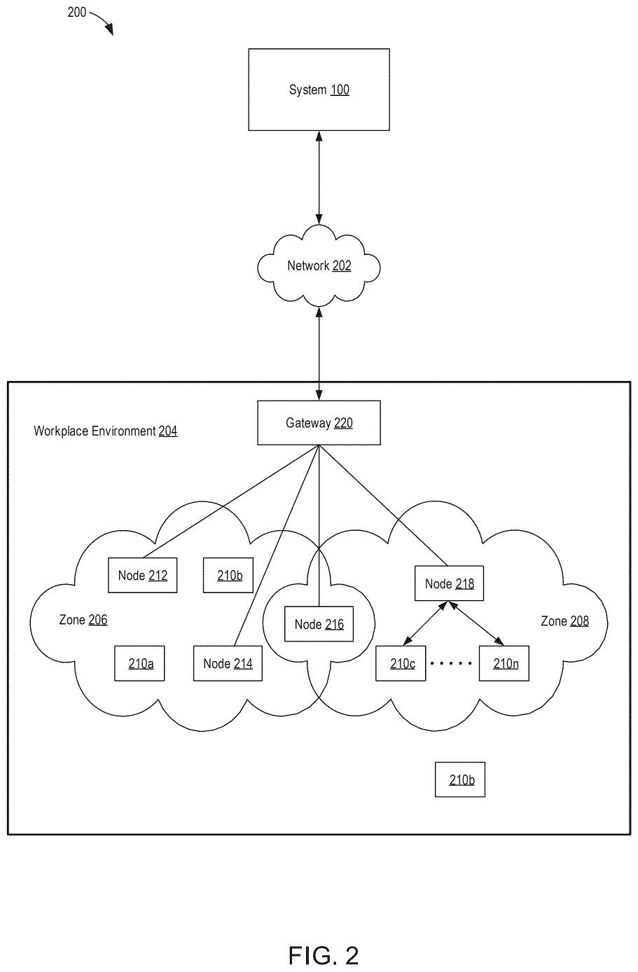

Reference is taken from FIG. 2, illustrating a workplace environment 204 in which the system 100 is deployed. As shown, the workplace environment 204 is divided into a plurality of zones, zone 206 and zone 208, based on operational activities of the each zone. For example, for a Hotel, zone 206 can be a kitchen, and zone 208 can be a cash counter. A plurality of employees working in the workplace environment 204, are assigned badges that can be RFID tags, to help detect presence of an employee in a zone.

An employee is allocated to a zone based on work experience and performance. For example, as shown, employees 210a and 210b are allocated to zone 206. Further, employees 210c-210n are allocated to zone 208. Each zone is equipped with one or more nodes. For example, zone 206 has three nodes such as node 212, node 214 and node 206, and zone 208 has node 218. The nodes 212-218, can be routers that communicate with a gateway 220. A node that is located within a zone, basically, senses presence of an employee within the zone, and streams live data of events, occurrences, and presence of employees to the gateway 220. The live data can be in the form of a video, images, or RFID information received from badges attached to the employees 210a-210n. The gateway 220 further communicates the live data of events, occurrences, and real-time location of employees, and activities of the employees in a time-series format to the system 100 via a network 202. The network 202 can refer to a communication network, such as a Local Area Network (LAN), a Wide Area Network (WAN), or a wireless network like Wi-Fi, facilitating seamless data exchange and connectivity between devices, systems, or modules within the operational environment.

The availability module 102 records the real-time location, and the activity data for the each employee received from the gateway 220, over the period of time. The availability module 102, also records the real-time location, the activity, the sales, and the profitability data associated with the each employee over the predefined time period in the database 104. In an embodiment, the availability module 102 monitors a proximity and location data using advanced real-time telemetry technologies to optimize workforce management and task assignments. These technologies encompass a range of tools such as Bluetooth Low Energy (BLE), LoRa (Long Range), GPS, camera-based facial recognition systems, or equivalent solutions. BLE allows for precise proximity detection by leveraging short-range wireless communication, making it ideal for indoor environments such as retail stores or warehouses. LoRa technology, on the other hand, is particularly effective for long-range and low-power communication, which is suitable for expansive facilities or outdoor environments. GPS provides highly accurate location tracking for outdoor use, enabling real-time monitoring of employee movement across large geographical areas.

Camera-based facial recognition systems offer dual functionality by not only verifying employee identity but also determining their presence in specific operational zones. These systems can also integrate seamlessly with attendance and security protocols, ensuring compliance with workplace policies. The system 100 is designed to remain agnostic to specific location tracking technologies, meaning it can adapt to and incorporate emerging technologies or existing infrastructure within the workplace environment. This flexibility ensures that the system can operate efficiently in diverse settings, whether indoor, outdoor, or a combination of both, without being limited to a single technological standard.

Furthermore, the collected location and proximity data are processed in real-time to enhance workforce optimization. For instance, proximity information can help identify employees closest to specific tasks or areas requiring immediate attention, thereby reducing response times and increasing efficiency. Simultaneously, the system employs robust data protection measures to ensure that the use of telemetry technologies complies with applicable privacy laws and regulations, safeguarding employee rights and maintaining trust.

The database 104 can be a time-series database, that logs series of timestamped data along with a timestamp. In an embodiment, the database 104 stores a real-time location, activity, sales and profitability data of the each employee over a predefined time period in a time-series format; and a sales and profitability data of each shift over the predefined time period in a time series format.

The availability module 102, also records the sales and the profitability data of each time unit, where a time unit can be 1 hour, 1 shift or a set amount of time programmed by the user, over the predefined time period in the database 104. In an example, the workplace environment 204 can have a plurality of shifts, for example, a morning shift where a set of employees are required to work from 8 am to 8 pm, and an evening shift where another set of employees are required to work from 8 pm to 8 am. Other arrangement of shifts can also be envisaged. Each shift would have target sales figures, and profitability targets to be achieved. For instance, a target sales figure for a morning shift of a restaurant would be lesser, than a target sales figure for an evening shift. The described invention allows a granular control per time unit allowing visibility on the performance of the company on a per time unit basis, allowing to modify roles, assign personnel and adjust to incidents in a faster much more efficient manner than traditional systems.

The performance matrix 106 classifies the plurality of employees 210a-210n, into one or more performance categories 108a-108n based on performance data of each employee. The categorization module 106, also ranks the plurality of employees 210a-210n, based on the performance data. The performance data of the each employee) e.g. 210a) comprises historical sales figures generated by the each employee (e.g. 210a), profitability data associated with the sales figures, an experience, a qualification, customer feedback, peer feedback, tip amount received, task completion rates, task-specific efficiency adherence to schedules, and compliance adherence.

The policy module 122, integral to the system, incorporates both workflow and regulatory policies. In the disclosed technology, policy module 122 is implemented using a relational database architecture. This architecture is based on a relational model that establishes specific rules and guidelines for the organization of data, including principles of data normalization. A Relational Database Management System (RDBMS) is employed, which conforms to these prescribed rules. Within this system, data is methodically classified, with each piece of data designated as a unique instance of a ‘relation’. These relations are organized into distinct tables wherein each table comprises multiple rows and columns. Each row within a table corresponds to a specific data item, while each column delineates an attribute that is common across all data items in that table, thereby facilitating structured data storage and retrieval.

These are meticulously designed to establish limits on various aspects of workforce management, including the number of hours certain employees are permitted to work, overall staffing headcount, and specific staffing ratios. This comprehensive framework ensures that all scheduling adheres strictly to both internal company policies and external legal requirements, thus maintaining regulatory compliance across operations.

Parallelly, the work schedule 116 is crafted leveraging artificial intelligence, which meticulously analyses the staffing mix for each shift while considering employee preferences. This AI-driven approach allows for the creation of the work schedule (116) that not only aligns with the stringent constraints set forth by the policy module 122 but also optimizes employee satisfaction and operational efficiency. The schedule is thus a balanced amalgamation of compliance and preference, ensuring that each shift is staffed optimally to meet both business needs and employee expectations. This synchronization of scheduling with policy constraints and employee desires epitomizes the advanced capabilities of the system in managing complex staffing requirements effectively.

A ranking module 124 is further configured to determine a ranked list of the plurality of employees based on the ranking; wherein the ranking excludes biasing factors comprising gender, race and age; select an employee (e.g. 210a) from the ranked list for a real time task based on predefined criteria that saves the employee (e.g. 210a) from exceeding an overtime threshold; and providing the ranked list and the one or more performance categories to the feedback module 112 as an input to update the workplace policies, the one or more of the staffing mix and the work schedule.

The performance matrix 106 is also designed to categorize the plurality of employees into the one or more performance categories (108a-108n) based on the ranked list, associate the one or more performance categories (108a-108n) with one or more of promotion and dismissal eligibility; and determine one or more of a salary, promotion and dismissal of an employee based on a rank provided to the employee within the ranking list.

The performance matrix 106 calculates a total working hours for the employee (e.g. 210a) based on the work schedule; applies the overtime threshold to the total working hours; and allocates the real-time task to the employee (e.g. 210a) when the inclusion of a time duration for completion of the real time task to the total working hours still amounts to less than the overtime threshold.

The scheduling module 110 determines a staffing mix for each shift based on the one or more performance categories (108a-108n), the availability data, and an anticipated sales targets for the each shift; and generates a work schedule based on the staffing mix for the each shift, that complies with workplace policies and existing regulatory requirements. The existing regulatory requirements comprises applicable labor laws and workplace policies. In an embodiment, the workplace policies comprise a plurality of employee roles within the workplace environment; a designation of a plurality of operational zones within the workplace environment, each operational zone corresponding to a defined set of activities and responsibilities; and a distribution of the plurality of employees across the plurality of operational zones, specifying a number of employees and a role of each employee assigned to each operational zone at a given point in time.

The feedback module 112 suggests an updated work schedule based on the availability, the performance data of each employee and anticipated sales targets for each shift, wherein the updated work schedule optimizes the staffing mix to meet the anticipated sales targets. The system 100 further includes the scheduling interface 114 via which access to the ranked list of the plurality of employees (210a-210n) is enabled. The ranked list may also include a real-time evaluation of each employee, and the performance data associated with each employee. Providing access to this ranked list to the plurality of employees (210a-210) ensures transparency, allowing employees to stay informed about their performance metrics and the corresponding performance category they belong to. This real-time evaluation enables each employee to understand their standing within the organization, offering insights into potential career advancements, such as eligibility for promotions based on strong performance. Conversely, it also serves as a warning mechanism for employees at risk of dismissal or termination due to underperformance, fostering accountability and motivating improvement.

The computing device 130 is further configured to swap an employee that becomes unable to work a shift for an available employee where the available employee is chosen using artificial intelligence, historical data, preferences and the policy module 122 to choose an employee that maximizes profitability keeping employees at the shifts they do best while complying with policies in the policy module 122. The existing regulatory requirements comprise applicable laws, and labor regulations, including but not limited to child labor laws, OSHA scheduling limits, and hour thresholds for overtime and part time workers. The performance data of each employee comprises historical sales figures generated using key performance indicators assigned to that employee. KPIs include, but are not limited to experience, qualifications, customer feedback, peer feedback, gratuity, task completion rates, adherence to schedules, and workflow policy compliance. The availability data includes shift preferences, and an existing workload of each employee.

The ranking module 124 is configured to rank the plurality of employees based on the performance data; and determine a ranked list of the plurality of employees based on the ranking, where the ranking excludes biasing factors comprising gender, race and age. The ranking module 124 is further configured to calculate a total working hours for the employee based on the work schedule; apply the overtime threshold to the total working hours; and select an employee from the ranked list for real time shift adjustments based on predefined criteria including employee availability and regulatory requirements.

The scheduling interface 114 is further configured to enable access of the ranked list to the plurality of employees, wherein the ranked list further comprises a real-time evaluation and the performance data associated with each employee. categorize the plurality of employees into the one or more performance categories based on the ranked list; and associate one or more performance categories with one or more of promotion and dismissal eligibility.

The workflow policy refinement module 120 is configured to evaluate sales and profitability data of each shift; identify a deviation from one or more of the workplace policies, the staffing mix and the work schedule, when the sales and profitability data of the shift deviate significantly from anticipated sales and anticipated profitability; and detect and analyze patterns in expected versus realized sales and profitability, to identify suggested adjustments to workflow policies.

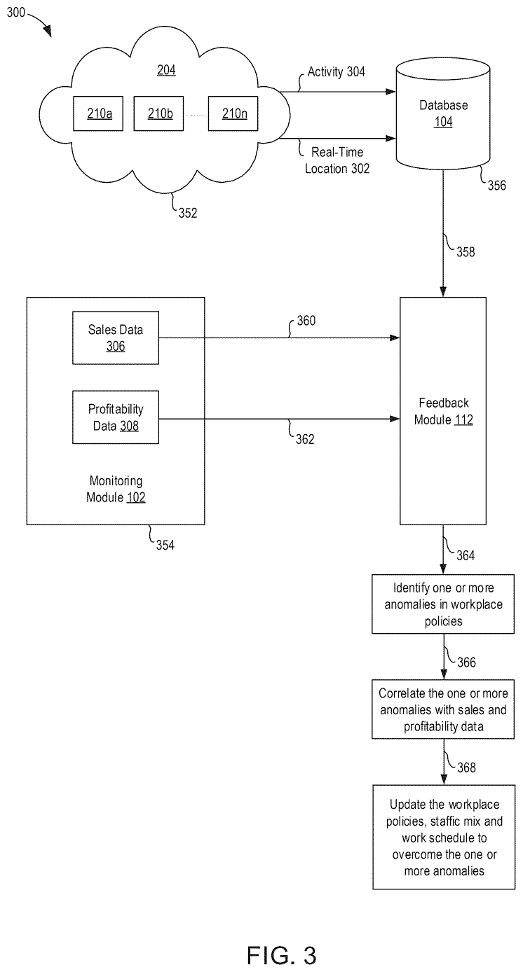

FIG. 3 is a flow diagram 300 illustrating a process of creating and updating workplace policies and work schedules for the workplace environment 204. As shown, at 352, a plurality of employees 210a-210n are working. At 356 real-time location 302 of each employee and activity 304 of each employee is retrieved and stored in the database 104.

At 354, sales data 306, and profitability data 308 of each employee and of each shift of the workplace environment 204, are retrieved by the monitoring module 102. At 360 the sales data 306 is provided to the feedback module 112.

At 362, the profitability data 308 is provided to the feedback module 112. At 358, the time series data of the real time location 302 of each employee and the activity 304 of the each employee is provided to the feedback module 112.

At 364, based on the sales data 306, the profitability data 308, the real-time location 302 and the activity 304, one or more anomalies in the workplace environment 204 are identified.

At 366, the one or more anomalies are correlated with the sales and profitability data. For example, if the sales and profitability data of a particular shift, say afternoon shift. of the workplace environment, say restaurant, are low then the lack in sales is correlated to an anomaly in the workplace policies or work schedule of the afternoon shift. Hence, an update in the workplace policies and work schedule of the afternoon shift would need to be updated into order to optimize the sales and profitability of the afternoon shift. Accordingly, at 368 the workplace policies, staffing mix and work schedule are updated to overcome the one or more anomalies. In the above example, if the correlation is identified as a lesser number of cooks available during the afternoon shift, resulting in the low profitability, then the workplace policy for the afternoon shift could be updated to include additional cooks. Say if the earlier policy mandated presence of only 1 cook, leading to delay in service and hence sales figures, then the workplace policy can be updated to increase a designated number of cooks to 2 or 3 in the afternoon shift, in order to optimize the sales and profitability of the afternoon shift.

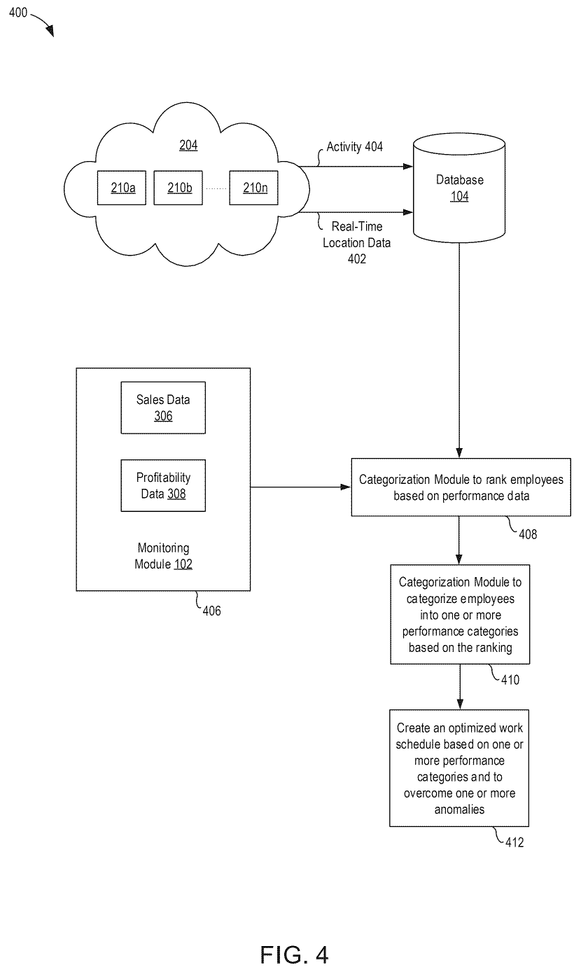

FIG. 4 is a flow diagram 400 illustrating a process of categorizing the plurality of employees (210a-210n) of the workplace environment 204 based on performance data and integrating the categorization with creating an optimized work schedule, according to an example embodiment. At 402, real-time location data of the plurality of employees (210a-210n) are fed into the database 104. At 404, activity data of the plurality of employees (210a-210n) are retrieved from the workplace environment 204 and fed into a database 104.

At 406, sales data 306, and profitability data 308 of the plurality of employees (210a-210n) are retrieved by the monitoring module 102 and fed to the categorization module 106. At 408, the categorization module 106 ranks the plurality of employees (210a-210n) based on a performance data. The performance data includes a sales figures included within the sales data, and profitability data 308 of the plurality of employees (210a-210n).

At 410, the categorization module 106 categorizes the plurality of employees (210a-210n) into one or more performance categories (108a-108n) based on the ranking. For example, employees that perform exceedingly well and bill highest profitability are categorized into category A comprising high performing employees, and employees that have underperformed could be categorized into Category C, comprising low performing employees. Similarly, employees meeting the targets and having an average performance can be categorized into Category B. At 412, an optimized work schedule is created based on the one or more performance categories and to overcome one or more anomalies.

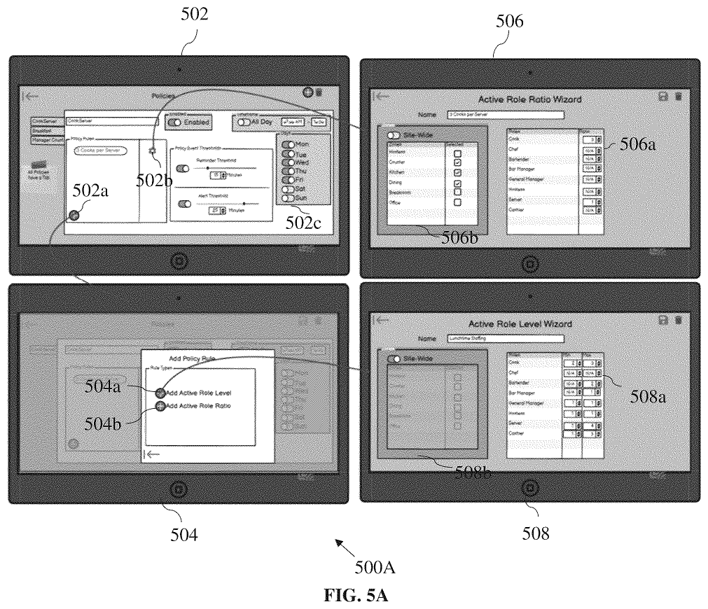

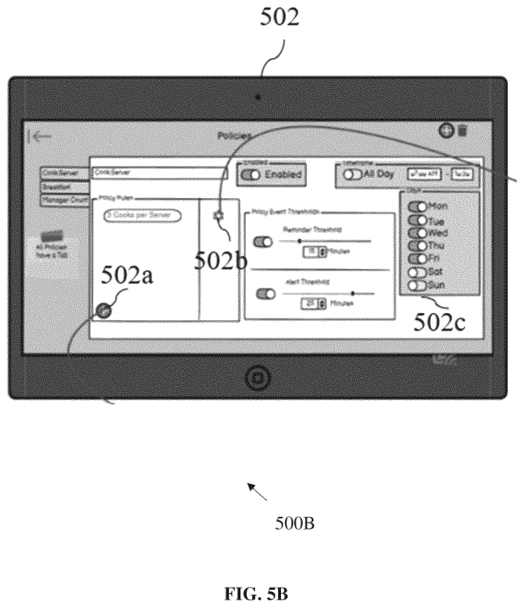

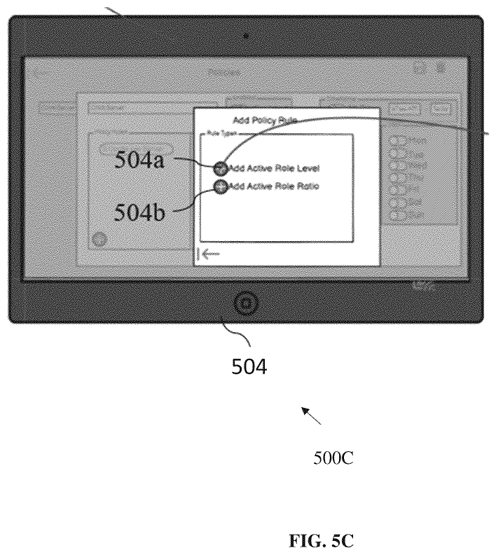

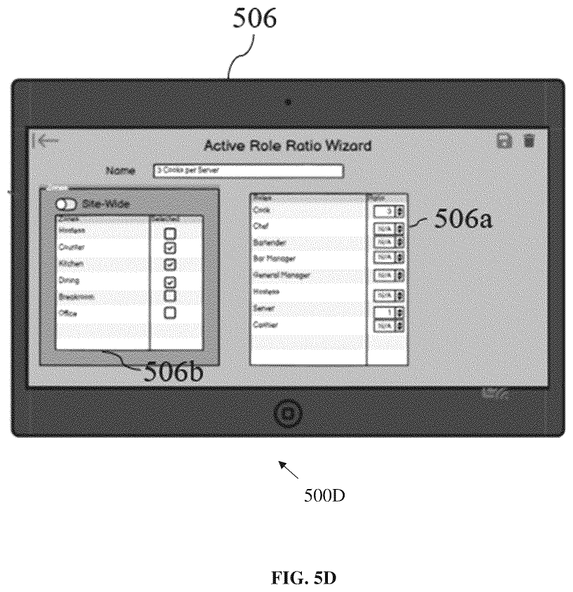

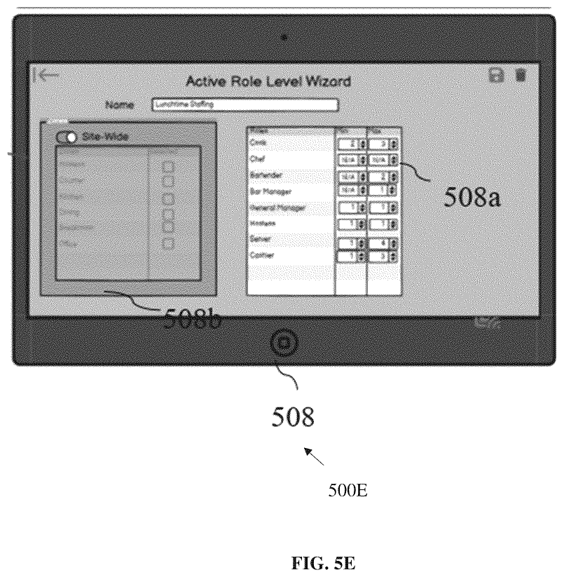

FIGS. 5A-5E illustrates a series of web dialog boxes 500 displayed on the interface 114 of the system 100. As shown in FIG. 5A, a series of web dialog boxes 502-508 facilitate the creation of workplace policies for a zone (e.g. 206, a kitchen) of the workplace environment 204, according to an example embodiment. FIG. 5B illustrates a view of the web-dialog box 502, FIG. 5C illustrates a view of the web-dialog box 504, FIG. 5D illustrates a view of the web-dialog box 506, and FIG. 5E illustrates a view of the web-dialog box 508. The interface is accessible by authorized users such as managers, or owner of the workplace who can view performance of the plurality of employees. As shown, in 502, discloses creation of a workplace policy “3 cooks per server”. The web dialog box 502 also depicts a reminder threshold to be given every 15 minutes, and alert threshold to be given every 25 minutes. These thresholds can be modified based on requirement. A number of days the policy is applicable is displayed in box 502c. As shown the policy is applicable from Monday to Frida. At 502a, an icon for adding additional workplace policies is provided. When the icon 502a is clicked, the web dialog box 504 opens. The web dialog box 504 comprises an icon 504a to add active role level, and an icon 504b to add active role ratio. When 504a is clicked, the web dialog box 508 opens. The web dialog box helps in adding a workplace policy for roles associated with the plurality of employees 210a-210n. At 508a for the workplace policy displayed in 502, sub-policy is applied in 508a. Number of cooks are selected from 2 to 3, number of bartenders are fixed to 2, number of bar managers is 1, number of general managers is 1, number of server is 1 to 4 and number of cashiers is 1 to 3. Similarly, when icon 502b is clicked, the web dialog box 506, “Active Role Ratio Wizard” opens up. The web dialog 506 discloses a site-wise or zone-wise allocation of employees in 506b, and an option to modify the zone-wise allocation is facilitated through an interactive box 506a.

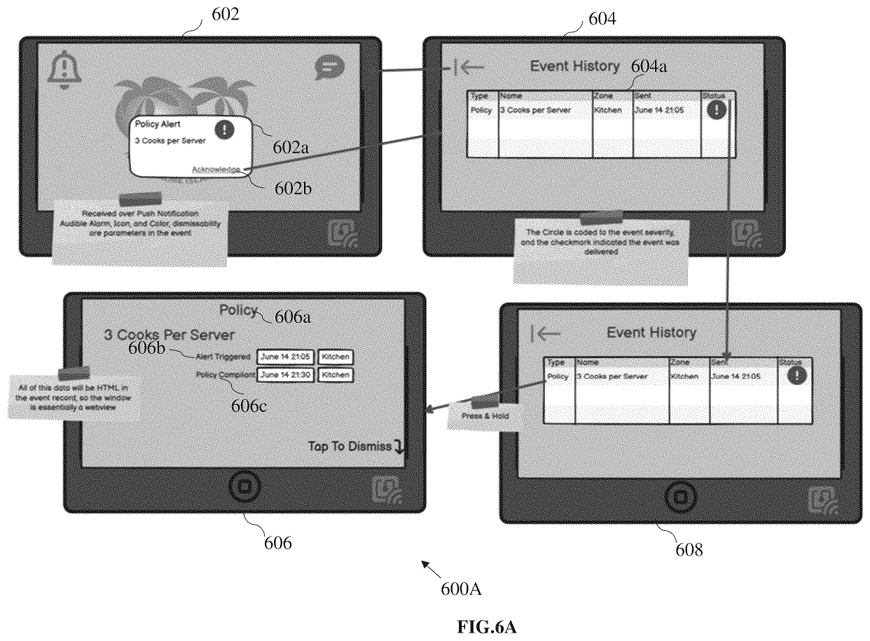

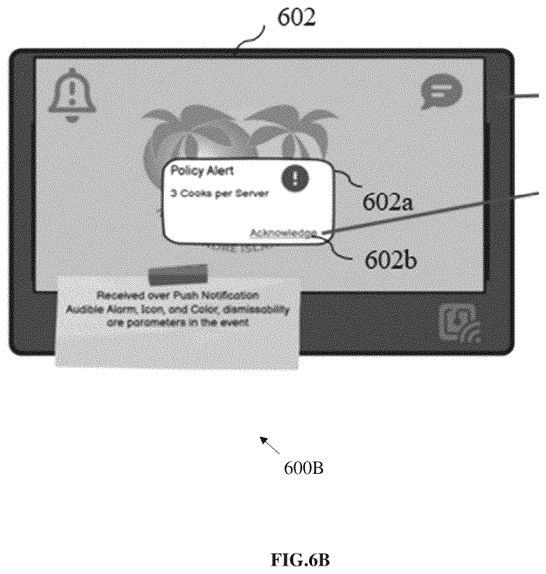

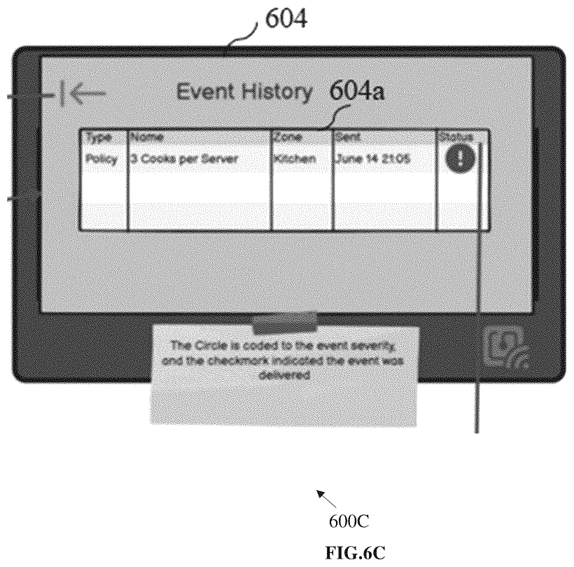

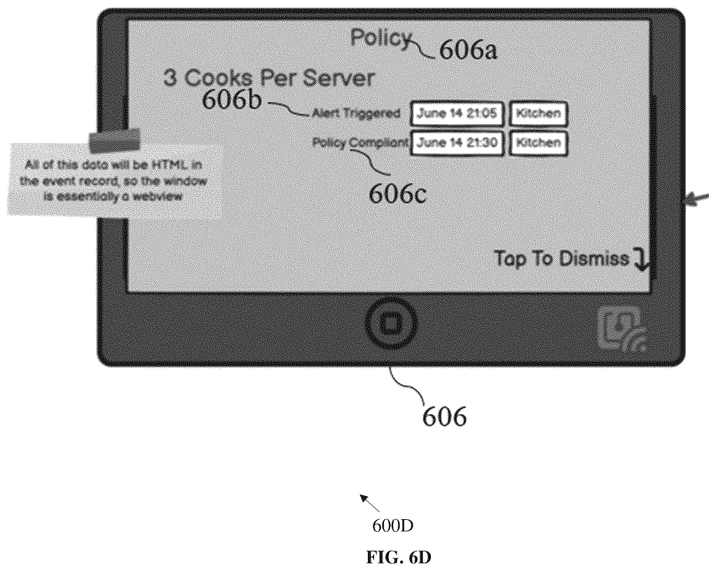

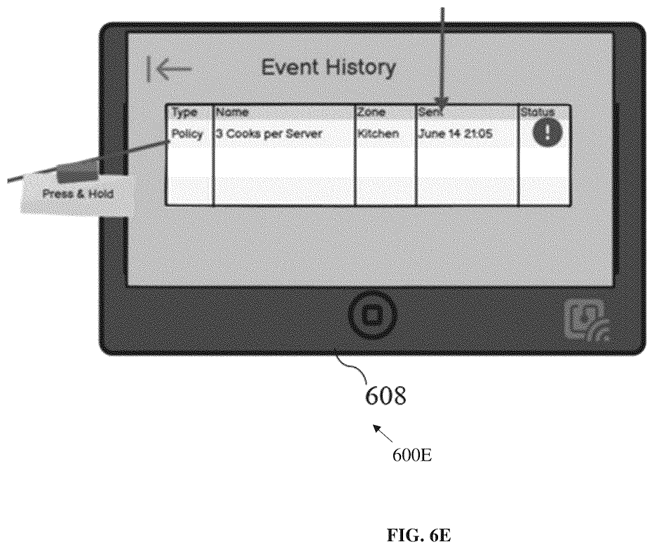

FIG. 6A illustrates a series of web dialog boxes 602-608 displayed on the interface 114 of the system 100, where violation of workplace policies is illustrated, according to an example embodiment. FIG. 6B illustrates a view of the web-dialog box 602, FIG. 6C illustrates a view of the web-dialog box 604, FIG. 6D illustrates a view of the web-dialog box 606, and FIG. 6E illustrates a view of the web-dialog box 608. Within the web dialog box 602, an alert 602a is displayed that mentions the policy “3 cooks per server” has been violated. At 602b, an acknowledgement button is present, which when clicked, opens up the web dialog box 604. Within 604, an event history 604a is displayed. The event history 604a displays a date and time “14 June 21:06” when the policy has been violated. A status of the policy is also displayed. The circle is coded to the event severity, and the checkmark indicates the event was delivered. When the policy in the event history 504a is pressed and held in web dialog box 608, another web dialog box 606 opens. In 606, details of the policy violation are displayed. At 606c, an alert is triggered and at 606c a policy complaint is registered. All the data in the web dialog box 606 is in an HTML format, and the window is essentially a WebView.

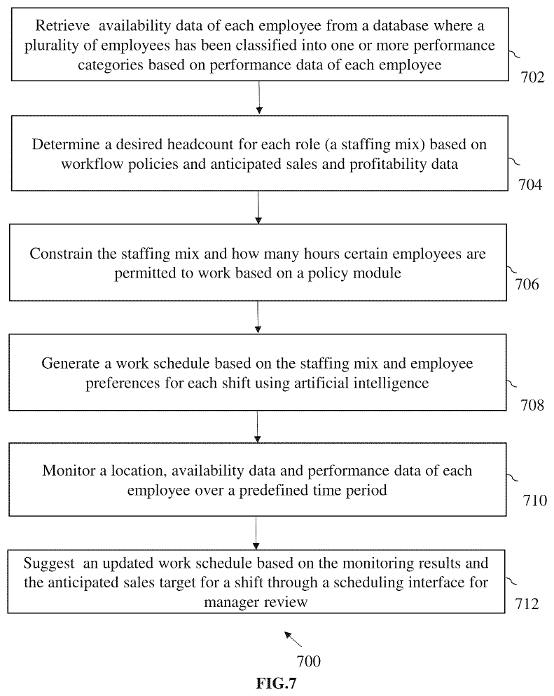

FIG. 7 is a flowchart 700 illustrating a method for developing work schedules for a plurality of employees in a workplace environment, according to an example embodiment.

At 702, availability data of each employee is retrieved from a database where a plurality of employees has been classified into one or more performance categories based on the performance data of each employee. This classification incorporates metrics such as historical sales figures, customer feedback, peer feedback, task-specific efficiency, adherence to schedules, qualifications, and compliance adherence. Additionally, the method ensures objectivity by excluding biasing factors such as gender, race, or age. Employees are ranked based on their performance, and a ranked list is generated to further aid in task assignment. This list is made accessible to employees, providing transparency and fostering motivation, while also associating performance categories with potential promotion or dismissal eligibility.

At step 704, a desired headcount for each role (a staffing mix) is determined based on workflow policies and anticipated sales and profitability data.

At step 706, the staffing mix and the number of hours certain employees are permitted to work are constrained based on a policy module. This process also takes into account workplace policies and operational requirements, such as distributing employees across defined zones based on specific activities and roles. To further streamline operations, the method integrates the ranking system with the workplace payroll system, ensuring that task assignments align with financial policies and avoid discrepancies. The staffing mix is carefully crafted to ensure compliance with applicable labor laws and to optimize the allocation of employees across roles and zones.

At step 708, a work schedule is generated based on the staffing mix and employee preferences for each shift using artificial intelligence. The schedule incorporates shift preferences, real-time employee locations, and existing workloads to ensure fairness and efficiency. It also takes steps to prevent employees from exceeding overtime thresholds, maintaining compliance with labor laws. By aligning the schedule with both organizational goals and employee well-being, this step ensures operational balance and employee satisfaction.

At step 710, the location, availability data, and performance data of each employee are monitored over a predefined time period. This monitoring involves tracking real-time location, activity levels, sales contributions, and profitability data, all of which are recorded in a database for future analysis. This continuous monitoring helps identify trends, anomalies, and areas for improvement within workplace policies, staffing strategies, and schedules. It also enables a robust evaluation of individual and team performance, further enhancing the accuracy of future planning.

Finally, at 712, an updated work schedule is suggested based on the monitoring results and the anticipated sales target for a shift through a scheduling interface for manager review. The updated schedule dynamically optimizes the staffing mix by considering real-time factors such as employee location, availability, and workload. Additionally, the method identifies any anomalies in workplace policies, staffing strategies, or schedules that deviate significantly from anticipated outcomes, such as sales or profitability targets. When such anomalies are detected, the workplace policies, staffing strategies, and schedules are updated to enhance operational efficiency. This step ensures continuous improvement and alignment with business objectives while maintaining fairness and compliance across all aspects of the workplace environment. The system and method enable significant improvements in workforce management by leveraging advanced data analysis and real-time monitoring. It classifies employees into performance categories based on comprehensive performance metrics such as sales figures, customer feedback, and adherence to compliance. By dynamically determining staffing mixes and generating work schedules tailored to anticipated sales targets, it ensures optimized resource allocation. Real-time monitoring of employee location, availability, and workload enables adaptive scheduling to address operational demands while complying with labor laws and workplace policies.

The described computer-implemented method facilitates the development of optimized work schedules for a variety of employees within a workplace environment. Initially, the method retrieves availability data of each employee from a database, where employees are classified into performance categories based on their performance data. This performance data might include historical sales figures influenced by key performance indicators (KPIs) such as experience, qualifications, customer feedback, and task completion rates. Utilizing this data, the system determines the required headcount for each role, factoring in workflow policies and anticipated sales and profitability. The staffing mix and employee work hours are then constrained by a policy module that includes regulatory policies such as limits on working hours, mandated by laws and labour regulations which may include child labour laws, OSHA scheduling limits, and overtime thresholds.

The work schedule is generated using artificial intelligence that considers both the staffing mix and individual employee preferences for each shift. This process ensures that staffing adjustments are optimal for increasing sales, profitability, and customer satisfaction. The scheduling interface, typically a web interface, and the monitoring of employees through sensors or electronic devices, allow for ongoing adjustments based on real-time data. For instance, if an employee becomes unable to work a shift, the system can swap this employee with another who is not only available but also maximizes profitability and compliance with established policies.

Further enhancements to the method include ranking employees based on performance data while excluding biases such as gender, race, or age. This ranked list of employees aids in making real-time shift adjustments, which are crucial for maintaining regulatory compliance and operational efficiency. Employees can access this ranked list, which includes real-time evaluations and is used to categorize employees for promotions or dismissals based on performance.

The method also continuously evaluates sales and profitability data for each shift, identifying any deviations from expected figures. Anomalies, once detected, prompt the system to provide timely feedback to managers and suggest real-time modifications to the staffing headcount or work schedule to better align with actual sales outcomes and profitability. For example, if a predefined workflow policy dictates a cashier to cook ratio of 3:1, but actual sales data suggests a ratio of 5:2 performs better, the system can suggest this adjustment to improve operational efficiency.

Overall, this computer-implemented method not only ensures compliance with regulatory requirements but also enhances workplace efficiency by dynamically adjusting workforce management practices based on comprehensive data analysis and real-time monitoring.

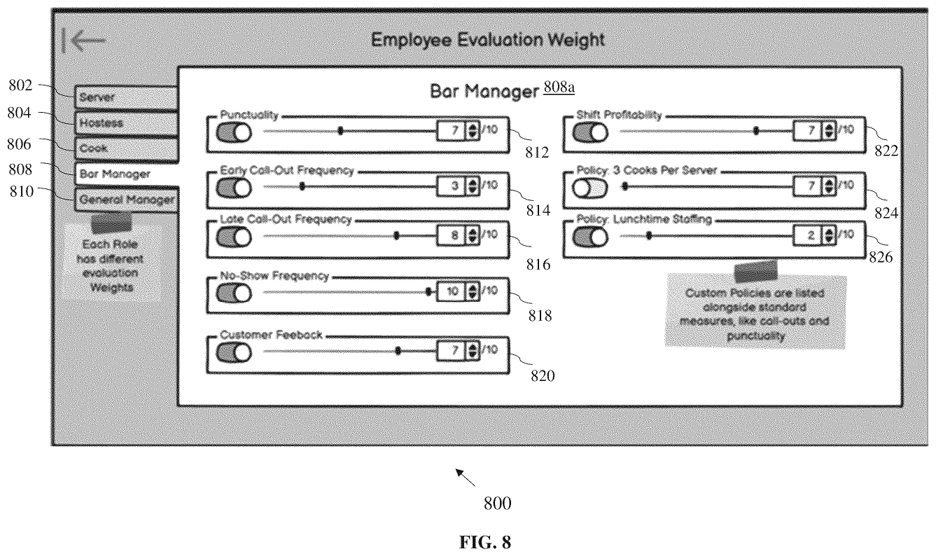

FIG. 8 illustrated an interface 800 for employee evaluation, according to an example embodiment. The interface 800 includes a category list of employees 802-810, for which evaluation is monitored. Examples of categories of employees are server 802, hostess 804, cook 806, bar manager 808, and general manager 810. The interface 800 depicts evaluation 808a of the bar manager 808. As shown, in the evaluation 808a a plurality of factors like Punctuality 812, Early Call-Out Frequency 814, Late Call-Out Frequency 816, No-Show Frequency 818, Customer Feedback 820, Shift Profitability 822, Policy: 3 Cooks Per Server 824, and Policy: Lunchtime Staffing 826, are used to evaluate the bar manager 808.

Each factor is given a predetermined weight based on performance of the bar manager 808. For example, as shown the Punctuality 812 score is 7, based on the attendance of the bar manager 808. Similarly, the Early Call-Out Frequency 814 value is 3, the Late Call-Out Frequency 816 is 8, the No-Show Frequency 818 is 10, the Customer Feedback 820 is 7, the Shift Profitability 822 is 7, the Policy: 3 Cooks Per Server 824 is 7, and the Policy: Lunchtime Staffing 826 is 2. Based on the weights given to each factor, an overall evaluation score is determined for the Bar Manager 808.

The integration of performance data with ranking systems ensures transparency by providing employees with real-time feedback and evaluations. It mitigates bias by excluding discriminatory factors such as gender, race, and age, fostering a fair workplace. The system supports profitability by identifying anomalies in workplace policies, staffing, and schedules, suggesting updates to enhance operational efficiency and sales outcomes.

Additionally, it prevents overburdening employees by tracking work hours and adhering to overtime thresholds. The ethical AI framework ensures equitable evaluations and removes bias, promoting a healthy work environment. Finally, the system's capability to integrate with payroll and task allocation modules ensures seamless operations, reducing financial discrepancies and enhancing overall productivity and satisfaction.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The readable medium or storage medium may be a built-in medium installed inside a computer device's main body, or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include, but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is

1. A computer-implemented method for developing work schedules for a plurality of employees in a workplace environment, the method comprising:
retrieving availability data of each employee from a database where a plurality of employees has been classified into one or more performance categories based on performance data of each employee;
determining a desired headcount for each role (a staffing mix) based on workflow policies and anticipated sales and profitability data;
constraining the staffing mix and how many hours certain employees are permitted to work based on a policy module;
generating a work schedule based on staffing mix, ranking, and employee preferences for each shift using artificial intelligence;
monitoring availability data and performance data of each employee over a predefined time period; and
suggesting an updated work schedule based on the monitoring results and the anticipated sales target for a shift through a scheduling interface for manager review;
wherein the performance data of each employee comprises historical sales figures generated using key performance indicators (KPIs) assigned to that employee; wherein the KPIs include, but are not limited to experience, qualifications, customer feedback, peer feedback, gratuity, task completion rates, adherence to schedules, and workflow policy compliance.

2. The computer-implemented method of claim 1,
wherein the policy module contains policies chosen from the group consisting of regulatory policies designed to constraint how many hours the certain employees are permitted to work, constraint staffing headcount and constraint staffing ratios;
wherein the suggested work schedule optimizes the staffing mix to increase sales, profitability, and customer satisfaction;
wherein the scheduling interface is a web interface; and
wherein the policy module, availability data, performance data, and employee preferences are stored together in a relational database.

3. The computer-implemented method of claim 1, wherein the policy module includes existing regulatory requirements, applicable laws, and labor regulations, including but not limited to child labor laws, OSHA scheduling limits, and hour thresholds for overtime and part time workers.

4. The computer-implemented method of claim 1, wherein the availability data includes shift preferences, and an existing workload of each employee.

5. The computer-implemented method of claim 1, further comprising:
evaluating sales and profitability data of each employee of a shift;
identifying an anomaly in one or more of the workplace policies, the staffing mix and the work schedule, when the sales and profitability data of the shift deviate significantly from anticipated sales and anticipated profitability;
providing timely feedback to the manager on duty;
evaluating the work schedule in real-time to provide recommendations to increase or decrease staffing headcounts when an anomaly is detected;
presenting suggested schedule updates to add or remove active staff; and
wherein the suggested schedule updates conform to the original schedule procedures, including employee availability, regulatory compliance, and workflow policies.

6. The computer-implemented method of claim 1, further comprising:
evaluating sales and profitability data of each shift;
identifying a deviation from one or more of the workplace policies, the staffing mix and the work schedule, when the sales and profitability data of the shift deviate significantly from anticipated sales and anticipated profitability; and
detecting and analyzing patterns in expected versus realized sales and profitability, to identify suggested adjustments to workflow policies.

7. A computer-implemented method used to identify a best-fit replacement for an employee that became unavailable on a company schedule shift comprising:
creating a list of replacement candidates by comparing a profile and a weekly accrued time of a list of available employees with a set of rules from a policy module and ensuring the replacement candidates meet the rules specified in the policy module;
ranking the replacement candidates list based on the performance data by having a computer processor access employee performance data in a database;
generating a best-fit order replacement candidate list by using the ranking replacement candidates list based on performance and employee cost into an artificial intelligence engine.
offering the shift to an employee in the best-fit replacement candidate list, in order of ranking through a messaging protocol, with a specified interval before the shift is additionally offered to the next employee; and
assigning the shift to the first employee in the best-fit replacement candidate list who accepts the offer.

8. The computer-implemented method of claim 7, wherein the messaging protocol can be a text message, an e-mail, a phone call, and a mobile application message.

9. The computer-implemented method of claim 7, wherein the profile of available employees includes experience, preferences, certifications, and address.

10. The computer-implemented method of claim 7 where the employee cost is calculated by
summing accumulated worked hours this pay period, the anticipated upcoming working hours based on the current work schedule, and the hours of the available shift;
loading the overtime threshold from a policy module in a database and comparing it to the adjusted total working hours;
loading the overtime multiplier from a policy module (e.g. 1.5); and
calculating the employee's cost for the shift by adjusting the hourly rated for hours above the overtime threshold by the overtime multiplier.

11. The computer-implemented method of claim 7, where performance data further includes:
measuring employee past performance based on calculated key performance indicators (KPI) data while working shifts is similar to the expected sales/activity volume of the shift being staffed.

12. The computer-implemented method of one of claim 7 or claim 11, where KPIs include at least key performance indicator selected from the group comprising of employee experience, employee qualifications, customer feedback, peer feedback, gratuities earned, historical task completion rates, and adherence to schedules.

13. The computer-implemented method of claim 7,
wherein the interval between offers made to employees is adjusted according to the best-fit delta between the two candidates, such that the more equivalent the two candidates are, the shorter the interval.

14. The computer-implemented method of claim 7 where ranking includes best-fitness to the shift
a. The replacement candidates are additionally ranked with a preference for a best-fit between the employee's experience and performance data and the historical data about the shift, such as the expected business and rigor of the shift.

15. The computer-implemented method of claim 7 where ranking further includes
preference for a best match between the original/unavailable employee's historical performance and the candidate's historical performance on shifts similar to the one being re-staffed.

16. The computer-implemented method of claim 7, wherein the list of replacement candidates includes employees assigned to the shift.

17. The computer-implemented method of claim 16, wherein an employee already assigned to the shift becomes part of the list of replacement candidates when his position can be easily replaced compared to the position of the employee that became unavailable.

18. The computer-implemented method of claim 7, wherein the policy module, profile data, availability data, and performance data are stored together in a relational database.
